(19) United States
(12) Patent Application Publication
(10) Pub. No.: US 2023/0140403 A1
(43) Pub. Date: May 4, 2023

(54) HYDRODEGRADABLE PACKAGING MATERIAL

(71) Applicant: Solubag SpA, Santiago (CL)

(72) Inventors: Roberto Carlos Astete Boettcher, Bío Bío (CL); Patricio Cabezas Alamos, Colina (CL); Cristian Andrés Olivares Matamala, Las Condes (CL); Alejandro Jose Castro Riquelme, Bío Bío (CL)

(21) Appl. No.: 17/517,914

(22) Filed: Nov. 3, 2021

(51) Int. Cl. B65D 81/05; B65D 65/46; B65B 11/00; B65B 55/00; B31D 5/00

(52) U.S. Cl. CPC B65D 81/052; B65D 65/46; B65B 11/004; B65B 55/00; B31D 5/0073; B31D 2205/0023

(57) ABSTRACT

The invention is directed to a water-soluble, environmentally-friendly, packaging wrap for the packaging of goods and parcels. The packaging wrap is formed by sealing together at least two sheets of water-soluble polymeric film to form unsealed areas within the wrap. After the goods or parcels are wrapped with the packaging material, air is then injected into the unsealed areas of the wrap to form air chambers to cushion the goods during transport.

### FIELD OF THE INVENTION

The present invention relates in general to packaging materials for parcels and other goods, methods of making the packaging materials, and methods for using the packaging materials to package such items. Specifically, the invention relates to a water-soluble bubble-type wrap packaging material that can be inflated upon use and which is hydrodegradable.

### BACKGROUND OF THE INVENTION

The shipping industry involves the packaging of goods that may spend days and even months in transit until their final delivery. These goods must be packaged in such a way that any possibility of breakage, denting or any other kind of damage is minimized to deliver the product in optimal condition to its final user. Poor packaging, on the other hand, increases the return of products which have arrived in a bad condition, entailing an enormous expense of money in transport, logistics, packaging, fees, and taxes in the case of international shipping, and reacquiring customer loyalty from final users who have received products in a condition inferior to the one at the time of purchase.

Due to the current COVID-19 pandemic, users are unable to leave their homes, thus causing an exponential increase in internet purchases, international purchases, and the purchase of basic goods. These circumstances have seriously strained the shipping industry, as it now must supply packages to users in a much wider array of locations, who cannot do their purchases in person, and also expect their products to arrive in the same condition as if they had been purchased in a brick-and-mortar store.

There are a wide variety of packaging material options for the protection of goods during the shipping process, including boxes, cardboard, envelopes, and different plastics, among others. However, some of the best shock-absorbing packaging implements are those designed as airtight plastics into which air is injected to form shock absorbing air chambers.

One example of the use of inflatable laminated materials for the packaging of products and parcels is described in European Patent No. 1355780 B1. A multi-bubble, shock-absorbing, formable, inflatable, strip packaging product designed to be interposed between and in conjunction with both the inside surfaces of a shipping container and the outside surfaces of one or more packaged objects within the shipping container is shown. When inflated, the material reduces or completely absorbs the transfer of shock loads exterior to the shipping container to the objects packed inside the shipping container. However, this inflatable product is made of highly polluting single-use, non-biodegradable, non-water soluble plastic and, therefore, not friendly with the environment.

WO 2009/101389 A1 shows a plastic or other film that incorporates a filler, wherein the filler comprises glass flakes with an average thickness of 10 nm to 2000 nm. Products that may be formed from this film include sleeves, protective packaging, bags, liners, house-wrap, over-wrap film, bubble and cushion film, packaging for food products, boil-in-bags, heat shrinkable film or bags, pouches, or thermoformed packages. The film is made from a polymer or copolymer selected from one or more of a polyolefin, polyester, PET, PBT and acrylic polymer. However, these materials are also highly polluting, single-use plastic films. Therefore, it is not friendly with the environment and it is not water-soluble. In addition, there is no mention whatsoever about this film being formable as a shock-absorbing inflatable material and no indication as to whether it may be stored in a flattened state for long periods of time.

ES 2619558 T3 mentions packaging to send objects in general and, in particular, packaging that comprises an external pouch and an inner inflatable liner, as well as an inflation pathway through which a portion of gas can be introduced into the inflatable liner. Adequate barrier materials may include a copolymer of ethylene vinyl alcohol (EVOH), polyvinylidene dichloride (PVDC), vinylidene chloride copolymers such as vinylidene chloride/methyl acrylate copolymer, polyamide, polyester, polyacrylonitrile, or mixtures of these. In some applications, metal foils, metallized substrates (e.g., metallized polyethylene terephthalate (PET), metallized polyamide and/or metallized polypropylene), among others, can be used. However, just as with previously-described products, the inflatable film is made of non-water-soluble, single-use plastic materials, making it highly polluting once discarded and, as such, not friendly with the environment and not water-soluble at all.

Therefore, inflatable materials for packaging and transporting goods are currently known and used. However, two major issues arise due to the exponential increase in online shopping and shipping of products by parcel or delivery. First, plastic packaging waste, already a major sanitation problem prior to the pandemic, is increasing due to the increase in use of single-use plastic materials for packaging. Second, due to the increase in shipments, transport companies have had to purchase and store large quantities of packaging equipment (e.g. plastics, boxes, pouches, etc.) to keep an adequate stock of packaging materials, which occupy considerable space in warehouses and reduce the space previously allocated for the storage of goods. This issue becomes even more urgent in the case of supplier-made laminated bubble wrap packaging, because a large volume of storage space is, practically speaking, occupied by “air.”

All single-use plastic material would be ultimately disposed of in a landfill site, taking up to several decades to degrade. In addition, a considerable part of this single-use plastic material, which is used as packaging material, reaches the oceans, and causes well-documented damages to marine ecosystems, a fact now acknowledged worldwide. In addition, plastic material can act as a source of infection for COVID-19, since it has been demonstrated that this virus is capable of surviving for several days on different surfaces, so it can remain active (and therefore infectious) for longer periods on materials such as plastic and stainless steel, between 72 and 168 hours on both (3 to 7 days), while on cardboard, the virus remains active for 24 hours. Neeltje van Doremalen et al. (2020), Aerosol and Surface Stability of SARS-CoV-2 as Compared with SARS-CoV-1. N Engl J Med. 382:16.

On the other hand, plastic packaging implements which are injected with air (such as air pillows and bubble wrap, among others) present a major drawback in that they must be stored in their “inflated” form to avoid losing their properties. This involves using much more warehouse space until they are finally used. Therefore, air injection is performed at the time the materials are manufactured.

Hence, optimal materials are clearly needed for the manufacture of implements for the packaging and wrapping of goods that can also be discarded in an environmentally-friendly manner, without contributing to the generation of more plastic waste or becoming a vector for the transmission of viruses (such as COVID-19), making an ideal option out of any packaging material that can be quickly degraded by the final user without being eliminated through household garbage. In addition, innovation is required in the materials and manufacture of inflatable packaging implements, so that they can occupy less warehouse space when stored and can also be formulated to be stored in their uninflated form for long periods of time, and to which air is injected only at their time of use as packaging to reduce the space occupied in the warehouse.

### SUMMARY OF THE INVENTION

One of the objectives of the present invention is to provide an environmentally-friendly inflatable material for the packaging of goods and parcels that would ensure the integrity of shipped goods, while reducing breakage or other damage, and made of environmentally-friendly materials in order to reduce the pollution caused by the excessive use of plastic in the shipping industry. Another objective of this invention is to provide a packing material that can be stored uninflated prior to its use in the packaging of goods, avoiding the excessive waste of warehouse space caused by the storage of currently known inflated packaging materials.

The present invention includes products such as water-soluble laminated bags, shopping bags made of a water-soluble non-woven fabric, water-soluble detergent films, and water-soluble sanitary masks. Such products may be made from water-soluble polyvinyl alcohol (PVA)-based material, which may be combined with different elements to form a material that can dissolve upon contact with either hot, tepid, or cold water, thus avoiding pollution caused by plastic waste.

Therefore, the present invention addresses several of the technical problems previously mentioned based on an environmentally-friendly packing material formed from a collapsed tubular roll of blown film, which is comprised of a water-soluble polymeric material that forms a first sheet and a second sheet arranged in a face-to-face relationship, forming alternating sealed areas and other unsealed areas, wherein the unsealed areas comprise connecting areas, which allow the continuous transit of an air flow through all unsealed areas and with the property of forming air chambers at the time of use, and with at least one air supply channel or duct to join the unsealed areas. The water-soluble polymeric material is made of polyvinyl alcohol (PVA). The invention includes a process for forming such packaging material and a process for the packaging of goods and parcels using this environmentally-friendly packaging material where, at the time of final use, the unsealed areas are inflated with an air flow to form air chambers with a defined volume. The environmentally-friendly packaging material of the present invention can be stored uninflated for months without deteriorating many of its properties and may be inflated only at the time it is needed for the packaging and/or shipping of goods.

### BRIEF DESCRIPTION OF THE DRAWINGS

A detailed description of the invention and a full and enabling disclosure of the present invention, including the best mode thereof directed to one of ordinary skill in the art, is set forth in the specification, which refers to the appended drawings, in which:

FIG. 1 is a top view of an embodiment of the water-soluble inflatable material of the present invention.

FIG. 2 is a top view of an alternative embodiment of the water-soluble inflatable material of the present invention.

FIG. 3 is a top view of another alternative embodiment of the water-soluble inflatable material of the present invention.

FIG. 4 is a top view of an another alternative embodiment of the water-soluble inflatable material of the present invention.

FIG. 5 is a cross-sectional view along line VV of FIG. 4 of one of the shapes of air chambers that can be formed.

FIG. 6 is a cross-sectional view along line VV of FIG. 4 of another of the shapes of air chambers that can be formed.

FIG. 7 is a cross-sectional view along line VV of FIG. 4 of yet another of the shapes of air chambers that can be formed.

All numerical references made throughout the description should be considered as part of the whole set of figures, since it may happen that, in the same paragraph, numerical references are made to elements that can be found in two or more different figures. The figures only act as supporting elements for a better understanding of the invention, without representing the components at a real or proportional scale. Nor can the invention be limited only to what appears in the figures, since they represent, in a pedagogical way, the relevant elements of this environmentally-friendly water-soluble material for the packaging of goods and parcels, and may not include elements or designs that are of general knowledge in the state of the art. The figures include models of the parts of the sheet, illustrating the arrangement of sections, edges, regions, and elements that form the water-soluble laminated material.

### DETAILED DESCRIPTION OF PREFERRED EMBODIMENTS

Reference now will be made in detail to the embodiments of the invention, one or more examples of which are set forth below. Each example is provided by way of explanation of the invention, not a limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. The following embodiments and aspects thereof are described and illustrated in conjunction with systems, tools and methods which are meant to be exemplary and illustrative and not limiting in scope. In various embodiments one or more of the above-described problems have been reduced or eliminated while other embodiments are directed to other improvements.

Thus, it is intended that the present invention covers such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### DETAILED DESCRIPTION OF PREFERRED EMBODIMENTS

For a better comprehension of the present invention, it is necessary to provide the following definitions, which should only be understood as elements that help in the understanding of the specific technical characteristics in this technical field.

As used in the present invention, the term “environmentally-friendly” describes a material that can be discarded in a clean manner, without polluting the environment, be it water, land or any ecosystem in contact with the material.

As used in the present invention, “packaging” relates to the process of and products for arranging parcels or goods to protect them during their handling, storage, transportation, and disposal until they reach the end user.

As used in the present invention, the term “parcels” refers to a package sent through a postal or shipping service by a sender to a receiver. Generally, this term is used when the package is sent over long distances.

As used in the present invention, the term “water-soluble material” refers to any material that can be diluted in a liquid, primarily water, to cause disintegration.

As used in the present invention, the term “air chambers” refers to the space intended to contain injected air. In this case, the laminated material comprises sealed and unsealed areas that enable the formation of a space where air can be injected and form a shock-absorbing cushion or mattress.

As used in the present invention, the term “collapsed tubular roll” refers to the tubular polymeric material that is formed from a blow molding film-forming machine, technically known as “blown film,” which, after its formation by blowing, is pressed by pressure rollers that compress the material so that the tubular polymeric material forms a double sheet material, which is then rolled up.

As used in the present invention, the term “heat sealing” refers to a technique for the joining/welding of different materials by means of pressure and temperature, without the use of seams, joining either one thermoplastic to another thermoplastic or to other compatible material, by using a heat-sealing machine.

As used in the present invention, the term “embossing” refers to a process to produce an engraving on a material by the effect of exerted pressure. It is possible to emboss motifs either in relief or in recesses.

As used in the present invention, the term “extrusion” refers to a process used to create objects with a defined and fixed cross-section, where different forces, pressures or stresses are applied to a given raw material, allowing the material to be “pushed” or “extruded” through a die to a desired cross-section.

As used in the present invention, the term “density” is a magnitude referring to the amount of mass in any given volume of a substance or a solid object. In the case of polymers, these can be of low or high density and therein lies the use that can be given to them, either to produce rigid or malleable materials, for extrusion or melting processes, and/or to withstand high or low temperatures, among others.

One of the advantages of the water-soluble inflatable material for the packaging of goods and parcels of the present invention is that it is made of an environmentally-friendly water-soluble polymer, allowing for its dissolution in any temperature water, either cold or hot (depending on the design of the polymer), reducing the enormous environmental impact caused by plastic waste and, in particular, by the growing demand for plastic materials suitable for the packaging of goods that are shipped by courier (or delivery), which is a situation intensified by the current COVID-19 pandemic, since final users cannot purchase the wide variety of goods they need in person, thus creating an increasing demand for the services of external courier and shipping businesses to have their purchases delivered to their homes, naturally requiring said purchases to arrive in perfect conditions.

A second important advantage is that the packaging material can be degraded in hot water. Indeed, once the goods have been delivered, this laminated material can be dissolved in hot water to prevent it from becoming an undesirable waste for the environment. This also prevents it from becoming a source of COVID-19 infection if it is disposed of directly as household garbage, since it has been demonstrated that the virus can last for days on different surfaces (such as plastic), which may still be a source of infection for garbage collectors, who must handle household waste containing parcel packaging that may be contaminated with the virus and transmit the disease. The packaging material is formed from a water-soluble polymer, preferably polyvinyl alcohol (PVA). It is known that PVA is a polymer that has the property (depending on its composition) of “determining” the temperature at which it decomposes in water. Therefore, an advantage of the present invention is that the packaging material can be formulated and engineered to begin to disintegrate at set temperatures, such as 55° C. This is extremely important because, according to recent reports, COVID-19 can be safely eliminated at 56° C., therefore, eliminating the packaging material in hot water is extremely advantageous, since the virus is eliminated and the packaging material is also dissolved.

Yet another advantage of using PVA as a material for the formulation of the sheets is that it maintains its characteristics, even after stored for long period of times in uninflated form. Consequently, it is no longer necessary for shipping, courier, and delivery businesses to store the material in its inflated form (a considerable problem with current materials), a practice that is an enormous waste of storage space. The present invention averts such waste (by storing the material as uninflated sheets) and the material is injected with air only when a product is wrapped or packaged to be shipped as a parcel.

Additionally, as mentioned previously, one of the properties of PVA as a polymer (depending on its composition) is that its decomposition temperature in water can be “programmed”. Therefore, one of the advantages of the present invention is that packaging material can be formed to dissolve in both hot and cold temperatures, a crucial factor considering shipping conditions. For example, material dissolving in cold temperatures, in normal sanitary conditions, may be useful when it is certain that there has been no contact with pathogen agents. On the other hand, material dissolving in hot temperatures may be useful when it is necessary to ensure it will not act as a vector for pathogen agents.

Polyvinyl alcohol, as a water-soluble polymer, is widely used in viscose fibers, adhesives, coatings, and the like. At the same time, PVA is highly biodegradable and its biological and chemical oxygen demand is extremely low. Therefore, by solubilizing the bag made from PVA, there is no contamination or damage to water quality. The dissolution of PVA in the soil not only does not cause pollution or damage to the soil, but also plays a role of soil improvement and water retention, allowing it to become an environmentally-friendly material. But, due to its extremely low performance in thermoplastic processing, it is rarely used as a thermoplastic in processing and molding.

Thus, through the present invention, an improvement has been developed in inflatable materials useful for the packaging and shipping of goods, which must reach the end user undamaged, and where the present laminated material is environmentally friendly.

Finally, the density of the PVA polymer used for the material of the inventive product enables the easy dissolution of the material when in contact with water, a feature that is unavailable in the packaging polymeric materials that are currently used.

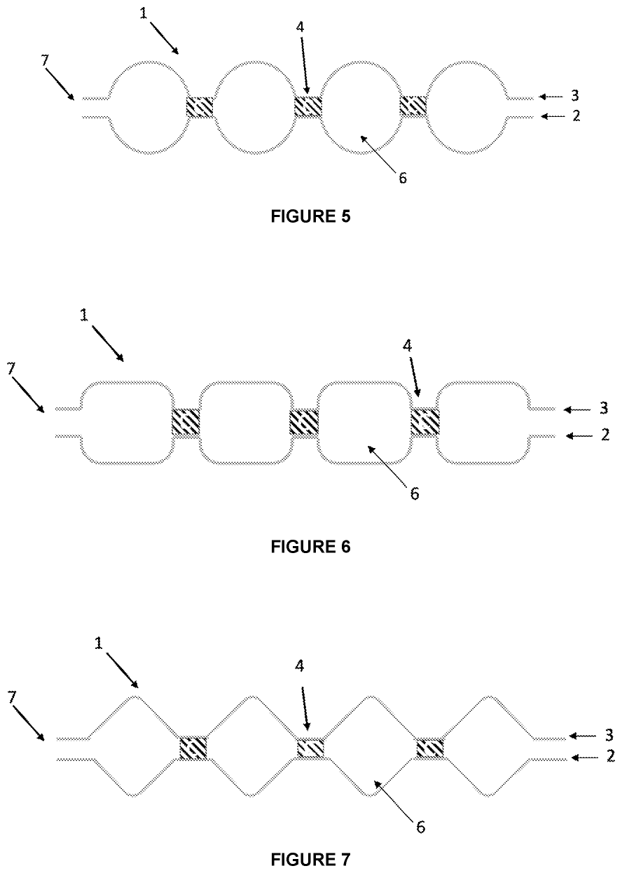

In the Figures, an environmentally-friendly packaging material 1, which may be formed from a collapsed tubular roll of blown film or through cast methodology, for the packaging of goods and products, comprises a first sheet 2 and a second sheet 3, both of which are made from a water-soluble polymeric material, are arranged to face each other to form a laminate. As shown in FIGS. 5-7, first sheet 2 and second sheet 3 are sealed together to form alternating sealed areas 4 and unsealed areas 5 such that the unsealed areas 5 comprise connecting passageways 8 internal within the packaging material 1 that allow the continuous transit of an air flow through some or all of the connected unsealed areas 5. The packaging material 1 has one or more air supply channels or ducts 7 through which air may be blown into the unsealed areas 5 to form air chambers 6 filled with air supplied through air supply channel 7.

The laminated material 1 can have dimensions corresponding to the capacity of the machinery used in its manufacture and/or to the dimensions and characteristics desired for the packaging material itself.

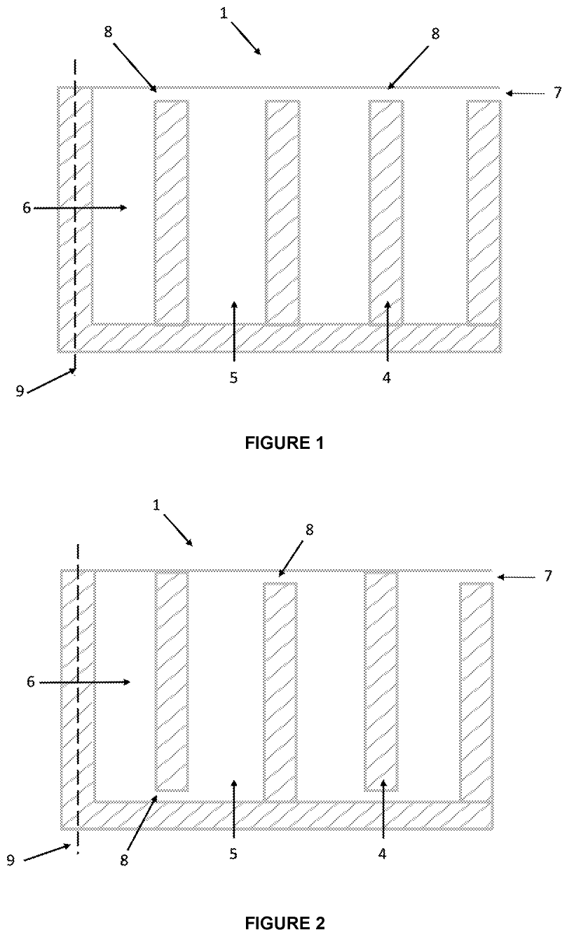

In FIGS. 1-4, the hatched areas show the sealed areas 4 and the unhatched areas show the unsealed areas 5 of the sheets arranged face-to-face from a top view. FIGS. 5-7 show cross-sectional views sealed areas 4 (hatched).

In FIGS. 1-4, different formations of the water-soluble inflatable packaging material are shown, but all have unsealed areas 5 connected on one of their sides to adjacent air chambers by means of connecting passageways 8 that allow a continuous air flow to pass between them. Other embodiments can include multiple air supply channels 7 to through which air may be supplied to groups of unsealed areas 5 to form sets of connected air chambers 6 when filled with air (shown in cross-section in FIGS. 4-6).

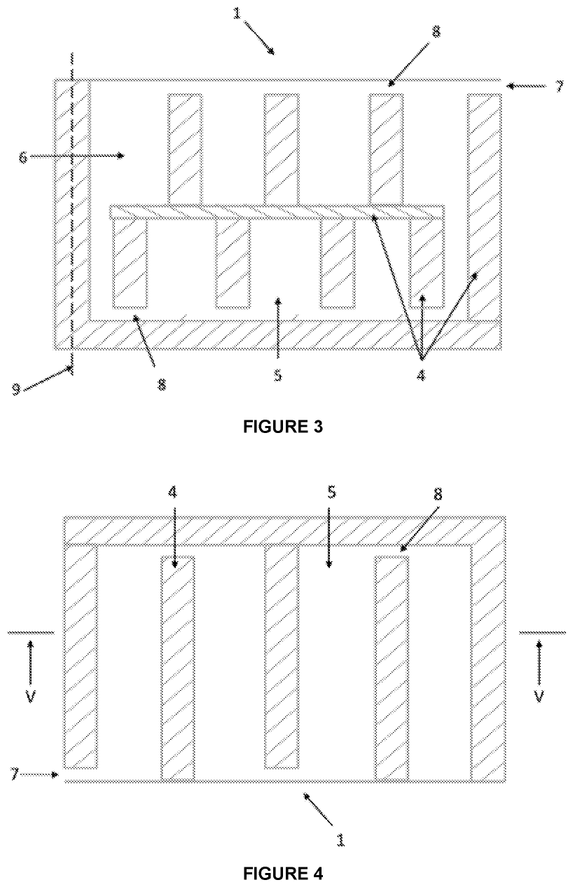

In FIG. 1, connecting passageways 8 are identically arranged within the upper area (as view from the top) of the packaging material 1 in relation to the unsealed areas 5 (air chambers 6 when filled with air). FIG. 2, on the other hand, shows a different pattern for the water-soluble inflatable packaging material 1 where each unsealed area 5 (air chamber 6 when filled with air) is linked by connecting passageways 8 on its upper side and, alternately, on its lower side, to adjacent unsealed areas 5. FIG. 3 shows another pattern for the water-soluble inflatable packaging material 1 where each unsealed area 5 is linked by connecting passageways 8, but a sealed area is at the center of the material, forming alternating air chambers 6 on and under this central sealed area when filled with air, and where the air chambers 6 are unaligned in the upper area with respect to the lower area, and the connecting passageways 8 link the connecting air chambers 6 using the same relative position or different relative positions. FIG. 4 shows a pattern similar to that shown in FIG. 2.

The arrangement of the unsealed areas 5 shown in FIGS. 1-4 may be understood as only one of the many possible variations in the location, size, and distribution of filled air chambers 6 in the packaging material 1. The possibilities for the location, size and distribution of the air chambers 6 in the laminated material are as numerous as the manufacturer may wish and should not be limited by the figures or the description herein.

The face-to-face arrangement of sheet 2 and sheet 3 is shown in cross-section in FIGS. 5-7, where the environmentally-friendly packaging material 1 for the packaging of goods and parcels comprises a first sheet 2 and a second sheet 3 of water-soluble polymeric material.

According to the present invention, said packaging material 1 is a water-soluble polymeric material based on polyvinyl alcohol, where the sealed areas 4 occupy a lesser volume than the unsealed areas 5 in the packaging material 1. In some embodiments, the unsealed areas 5 which are filled to form the air chambers 6 may be of the same size and shape. In other embodiments, unsealed areas 5, and thus filled air chambers 6, may be of different shapes and sizes throughout, or just in part, of the packaging material 1. Examples of such varying sizes and shapes are shown in FIGS. 5-7, which represent a cross-section of the packaging material in its in-use, air-filled state. These air chambers 6 have different shapes, so that when the laminated material is injected with air, each unsealed area 5 forms an individual air chamber 6, which may have a volume of circular, cylindrical, cubic, semicircular or any other shape and of any size. The shape of each unsealed area 5 that will form the air chamber 6 depends on the type of design and placement of the sealed areas 4. The present invention, consequently, is not limited to one specific shape for the air chambers 6, but they may also be square, triangular, round (bubbles), and of any other shape deemed convenient.

In another aspect of the invention and as shown in FIGS. 1-3, the packaging material 1 may include pre-cut lines 9, which are lines of weakness, to ease separation of packaging material 1 into longitudinal sections.

As previously mentioned, the density of the PVA to form the sheets that give shape to the packaging material may be between about 1.1 to about 1.55 g/cc, so that when the end user desires a material with higher mechanical strength, a higher density may be used, although with an understandably slower rate of degradation. When a lower density is desired, a material with thin sheets may be produced, with lower mechanical strength but more rapid degradation.

The formulation comprising PVA and from which the packaging material of the present invention is formed, can correspond to any known formulation. For example, the present applicants have already developed a series of inventions related to PVA-based materials soluble in water (cold and hot), manufactured as non-woven fabric bags, shopping bags, detergent sheets, and sanitary masks, as described and set forth in Publication No. WO2018/041262 (PCT/CN2017/100434; U.S. Pat. No. 10,954,372), WO2018/018172 (Chilean Patent Application No. CL2016001885; U.S. patent application Ser. No. 16/091,392) WO2018/045478 (Chilean Patent Application 2016002241; U.S. Pat. No. 10,717,954) and PCT/CL2020/050060. Those disclosures and the technical features of such water-soluble polymeric materials are incorporated herein in their entireties by reference thereto. Each disclosure contains a description of the manufacture process of a PVA-based water-soluble material, like the one utilized in the present invention, and where the design of the different sealed areas of the water-soluble laminated material of the present invention is executed by means of widely known techniques such as heat sealing, embossing, and extrusion. However, it is to be understood that other water-soluble and biodegradable materials may be used in the context of the present invention and the present invention is not limited to one particular formulation.

The environmentally-friendly packaging material 1 may be manufactured from a collapsed tubular roll of blown film. In this process, the water-soluble polymeric material may be mixed in a double extruder screw and the tubular roll of blow molding film formed using a thermoplastic extrusion blown film machine. The collapsed tubular roll of blown film thus is obtained is then unwound and a seal of a defined design is applied to the collapsed tubular material to alternately generate sealed areas 4 and unsealed areas 5, one or more air supply channels 7, and connecting passageways 8 that will allow the continuous transit of an air flow through some or all of the unsealed areas 5 to form air chambers 6 at the time of use.

The water-soluble polymeric packaging material 1 may be formed utilizing known manufacturing conditions, such as those set forth in WO 2018/041262, WO2018/018172, WO2018/045478, and/or PCT/CL2020/050060, which are referenced above and incorporated in their entireties by reference thereto. The processing conditions may be adjusted, as desired, so that the thickness of the water-soluble polymeric film of the tubular roll obtained by blow molding may be between 10 to 80 μm, or less than or more than such thickness, depending on the needs of the packaging. In particular, the packaging material 1 can be prepared by mixing the components of the formulation comprising PVA, followed by extrusion of the mixture by means of a twin screw extruder to form pellets of the formulation, with a blown film being formed by means of a thermoplastic extrusion blown film machine to obtain the collapsed tubular roll and, finally, applying a seal (through any known process such as, but not limited to, heat sealing, ultrasound, embossing, etc.) on the collapsed blown molding film, with the lines of weakness, sealed areas, unsealed areas, connection areas and air supply channels being thus formed.

The formed water-soluble, environmentally-friend packaging material may then be used to package all sorts of goods and parcels. When the goods or parcels are wrapped in the packaging material, air is then injected through the air supply channels 7 with equipment and instruments available to the end user for blowing air.

### EXAMPLES

The description of the required tests to demonstrate the effectiveness of the packaging material, in terms of its degradation capacity; occupied volume, and ability to maintain its properties after being stored for a long time, is demonstrated through the following comparative, but non-limiting, examples.

### Example 1: Formulation of the Water-Soluble Packaging Material and Disintegration Test

A packaging material made as set forth above was formed and tested for disintegration in cold water and in hot water. The packaging material was placed in 2-liter beakers, one with cold (i.e., room temperature) water and the other with hot (between 50-80° C.) water. The test determined the time the material took to dissolve, both with, and without, agitation.

In particular, one piece of laminated material measuring 40 cm×40 cm, made of a polymer designed to dissolve in cold water and a piece of laminated material measuring 40 cm×40 cm, made of a polymer designed to dissolve in hot water were used. In this particular instance, the laminated materials were made of the same polymers as set forth in U.S. Pat. No. 10,954,372, which is incorporated herein in its entirety by reference thereto. A magnetic agitator (CORNING®) operated at medium speed (700-800 rpm), a magnetic stirring bar, a chronometer, and 2 2-liter beakers were utilized and the dissolution time in cold and hot water was clocked with the results shown in Table 1.

TABLE 1
Test results for disintegration in water.

| | DEGRADATION TIME | | | |
|---|---|---|---|---|
| Degrada- | Cold water polymer (~18° C.) | | Hot water polymer (~60° C.) | |
| tion | Without | With | Without | With |
| level | agitation | agitation | agitation | agitation |
| 50% | 28 s | 12 s | 10 s | 4 s |
| 100% | 65 s | 32 s | 21 s | 11 s |

The results show that dissolution under agitation is faster than without agitation. A disintegration of 50% was considered to take place when there is partial disintegration of the material, disintegrated particles of the sheet are seen floating, and there are holes in various points in the sheet, leaving pieces of varying size and shape in the water-filled beaker. One hundred percent disintegration, on the other hand, is noted as taking place when the material is completely dissolved and integrated with the water and no particles of any size are visible inside the beaker. The aforesaid results show that the packaging material of the present invention can be completely dissolved in about 1 minute in cold water without agitation and almost immediately (4 seconds) in hot water with agitation.

### Example 2: Test for Warehouse Space Utilization

A packaging material made as set forth above was formed and tested for determining the volume of space taken up by the water-soluble packaging material when stored in the warehouse, up to the moment before it is used to pack or package goods or parcels for their shipment. One of the issues previously noted for current packaging materials must be stored in an inflated state (since that is how they are delivered by the supplier), thus requiring large warehouses in which to store the rolls of inflated material, causing enormous losses in terms of space and warehousing costs.

The water-soluble packaging material of the present invention was manufactured and cut into a strip with a length and width of 100 meters×50 cm respectively. The material was then stored as a coil (material rolled into a cylindrical shape) in two states—uninflated, as in the case of the present invention, and inflated. The space used by a coil of the material stored in the warehouse was measured in both its inflated and its uninflated state. The results are shown in Table 2.

TABLE 2
Results of the test for warehouse space utilization.
WAREHOUSE SPACE UTILIZATION

| | Dimensions | | |
|---|---|---|---|
| Sheet State | Length | Width | Volume |
| Uninflated | 100 m | 50 cm | 1 m³ |
| Inflated | 100 m | 50 cm | 32 m³ |

This demonstrates that the test water-soluble packaging material, when stored uninflated, utilizes 1 cubic meter, 30 times less than the space taken by the same amount of material in an inflated state, a factor that can vary much more, depending on the volume of the air chambers with which the laminated material is designed. Furthermore, utilizing different shapes for the air chambers (such as rectangularly-shaped air chambers) may allow for additional space saving as compared to materials using other shapes (such as bubble-shapes).

### Example 3: Inflation Test of the Packaging Material Over Time

A test designed to analyze whether the water-soluble packaging material could be stored in an uninflated state for extended periods of time, and what happened when, after the storage period, the material was inflated for the first time to the maximum capacity of the air chambers. Two types of packaging material were utilized for this test: 1) material designed for cold-water solubility, and 2) material designed for hot-water solubility. A strip of the water-soluble packaging material, designed to contain 60 cm³ within its air chambers when inflated to their maximum capacities, was utilized for this test. The packaging materials were tested to determine their inflation capacity over time, comparing the volume of inflation: i) immediately after manufacture; ii) 2 weeks after manufacture and storage; and iii) 2 months after manufacture and storage. The results are shown in Table 3, where the tests were performed three times for each condition.

TABLE 3
Results for the inflation test of the packaging material
over time (results in Latin form wherein comma represents
a period in English—e.g., 59.95 is the same as 59.95).

| | VOLUME OF INJECTED AIR (CM³) | | | |
|---|---|---|---|---|
| Inflation time | Replicate 1 | Replicate 2 | Replicate 3 | Average |
| Immediate | 59.95 | 60.06 | 60.92 | 60.31 |
| 2 weeks later | 60 | 60.18 | 60.58 | 60.25 |
| 2 months later | 61 | 60.6 | 59.89 | 60.50 |
| Immediate | 59.58 | 60.05 | 60.66 | 60.10 |
| 2 weeks later | 60.12 | 60.14 | 60 | 60.09 |
| 2 months later | 61.16 | 60.39 | 59.05 | 60.20 |

This demonstrates that the packaging material of the present invention can be stored uninflated for long periods of time, without losing its properties or its filling volume capacity. Therefore, warehouse space is not wasted when the present inventive material is stored. This is true for both the cold-water soluble polymer and hot-water soluble polymer, as the test sheet can be inflated to its maximum designed capacity (60 cm³) without tearing, bursting, or inflating into a smaller volume.

Therefore, the examples and description of the invention given above support the invention in any of its forms, demonstrating a technical advantage over the previous state of the art, since the previous state of the art for the packaging and shipping of fragile parcels does not include any inflatable packaging materials that are water-soluble, PVA-based, and capable of withstanding long storage periods in an uninflated state (without a decrease of their properties). Where such material is environmentally friendly, allowing for a more sustainable disposal, and avoiding the excessive accumulation of plastic produced by the growing demand of goods via delivery, this inventive alternative that, because of the isolation brought by the pandemic, is likely to last and expand in the future, as suppliers need to ensure that their products reach their customers in optimal condition.

The reach of the packaging material for the packaging of goods and parcels described in the present invention is not be limited to the components mentioned in the text itself (such as, for example, number of layers and designs), but it encompasses other designs that would benefit from a material such as the one from the present invention.

All references cited in this specification, including without limitation, all papers, publications, patents, patent applications, provisional patent applications, presentations, texts, reports, manuscripts, brochures, books, internet postings, journal articles, and/or periodicals are hereby incorporated by reference into this specification in their entireties, including all figures and tables, to the extent they are not inconsistent with the explicit teachings of this specification. The discussion of the references herein is intended merely to summarize the assertions made by their authors and no admission is made that any reference constitutes prior art. Applicants reserve the right to challenge the accuracy and pertinence of the cited references.

What is claimed is:

1. A water-soluble, biodegradable packaging material comprising at least two polymeric film sheets sealed together at certain sealed areas and wherein the packaging material comprises unsealed areas that are not sealed and one or more air supply channels through which air may be injected for forming air chambers in the unsealed areas of the packaging material that are filled with air.

2. The packaging material of claim 1, wherein the packaging material is completely dissolvable in water.

3. The packaging material of claim 1, wherein the packaging material is soluble in either cold or hot water.

4. The packaging material of claim 1 comprising a water-soluble polymeric material comprising polyvinyl alcohol.

5. The packaging material of claim 1, wherein the polymeric film sheets have a density of from about 1.1 to about 1.55 g/cc.

6. The packaging material of claim 1, wherein the polymeric film sheets have a thickness of from about 10 to about 80 μm.

7. The packaging material of claim 1, wherein the volume of unsealed areas exceeds the volume of sealed area.

8. The packaging material of claim 1, wherein the unsealed areas and the resulting air chambers have the same shape.

9. The packaging material of claim 1, wherein the unsealed areas and the resulting air chambers comprise two or more different shapes.

10. The packaging material of claim 1 comprising one or more pre-cut lines for separating the packaging material into longitudinal or transversal sections.

11. A process for forming the packaging material of claim 1 according to the following steps:
a. Forming a collapsed tubular roll of blown film comprising a water-soluble polymeric material into a first polymeric film sheet and a second polymeric film sheet arranged in a face-to-face relationship;
b. Sealing certain points of the first and second polymeric film sheets together to form alternating sealed areas and unsealed areas where the unsealed areas are connected via unsealed passageways that allow the continuous transit of an air flow through at least some of the unsealed areas; and
c. Forming at least one air supply channel for filling unsealed areas with air to form air chambers of a selected size and shape.

12. The process of claim 11, wherein the water-soluble polymeric material comprises polyvinyl alcohol.

13. The process of claim 11, wherein the polymeric film sheets have a density of from about 1.1 to about 1.55 g/cc.

14. The process of claim 11, wherein the polymeric film sheets have a thickness of from about 10 to about 80 μm.

15. A process for forming the packaging material of claim 1 according to the following steps:
a. Forming a cast material comprising a water-soluble polymeric material into a first polymeric film sheet and a second polymeric film sheet;
b. Arranging the first and second polymeric film sheets into a face-to-face relationship;
c. Sealing certain points of the first and second polymeric film sheets together to form alternating sealed areas and unsealed areas where the unsealed areas are connected via unsealed passageways that allow the continuous transit of an air flow through at least some of the unsealed areas; and
d. Forming at least one air supply channel for filling unsealed areas with air to form air chambers of a selected size and shape.

16. The process of claim 15, wherein the water-soluble polymeric material comprises polyvinyl alcohol.

17. The process of claim 15, wherein the polymeric film sheets have a density of from about 1.1 to about 1.55 g/cc.

18. The process of claim 15, wherein the polymeric film sheets have a thickness of from about 10 to about 80 μm.

19. A process for the packaging of goods or parcels using the packaging material of claim 1 by wrapping the goods or parcels with the packaging material of claim 1, injecting air through the air supply channels and into the unsealed areas of the packaging material, and sealing the air supply channels to form air chambers within the packaging materials.
